(19) United States
(12) Patent Application Publication
(10) Pub. No.: US 2026/0257297 A1
(43) Pub. Date: Sep. 3, 2026

(54) BEAM SHAPING DEVICE AND MACHINING DEVICE

(71) Applicant: SONY GROUP CORPORATION, TOKYO (JP)

(72) Inventor: YOSHITOMO ISOMAE, TOKYO (JP)

(21) Appl. No.: 18/865,897

(22) PCT Filed: Mar. 27, 2023
(86) PCT No.: PCT/JP2023/012269

§ 371 Date: Nov. 14, 2024

(30) Foreign Application Priority Data
May 24, 2022 (JP) 2022-084837

(51) Int. Cl. B23K 26/064; B23K 26/06; G02B 3/14; G02B 27/09; G02F 1/13

(52) U.S. Cl. CPC B23K 26/0648; B23K 26/0665; G02B 3/14; G02B 27/0955; G02F 1/1313

(57) ABSTRACT

A beam shaping device according to one embodiment of the present disclosure allows wide range and high accuracy modulation of an irradiation pattern to be performed. The beam shaping device of the present disclosure includes a spatial light modulator (10) of phase modulation type that displays a phase pattern corresponding to an irradiation pattern to be applied to an object (50), and an optical unit (21) that has a focal length variable and that converges light modulated by the spatial light modulator on the object.

### TECHNICAL FIELD

The present disclosure relates to a beam shaping device using a spatial light modulator (SLM) of phase modulation type and to a machining device.

### BACKGROUND ART

For example, in the field of laser machining, a method is proposed that uses a spatial light modulator of phase modulation type (for example, see Patent Literatures 1 and 2). In such a method, a phase pattern corresponding to an irradiation pattern to be applied to an object to be machined is displayed on the spatial light modulator. Further, it is also proposed that, for the phase pattern displayed on the spatial light modulator, a phase distribution for providing a lens function is superposed, allowing a function of adjusting a position in a depth direction (vertical direction) where the irradiation pattern is to be applied to.

### CITATION LIST

### Patent Literature

Patent Literature 1: Japanese Unexamined Patent Application Publication No. 2006-119427
Patent Literature 2: Japanese Unexamined Patent Application Publication No. 2016-75810

### SUMMARY OF THE INVENTION

In a case where a spatial light modulator is allowed to have a lens function, a spatial frequency of a phase pattern rises and a diffraction efficiency is lowered.

It is desirable to provide a beam shaping device and a machining device that allow wide range and high accuracy modulation of an irradiation pattern to be performed.

A beam shaping device according to one embodiment of the present disclosure includes: a spatial light modulator of phase modulation type that displays a phase pattern corresponding to an irradiation pattern to be applied to an object; and an optical unit that has a focal length variable and that converges light modulated by the spatial light modulator on the object.

A machining device according to one embodiment of the present disclosure includes: a spatial light modulator of phase modulation type that displays a phase pattern corresponding to an irradiation pattern to be applied to an object to be machined; and an optical unit that has a focal length variable and that converges light modulated by the spatial light modulator on the object.

In the beam shaping device or machining device according to one embodiment of the present disclosure, a phase pattern corresponding to an irradiation pattern to be applied to an object is displayed by the spatial light modulator, and light modulated by the spatial light modulator is converged on the object by the optical unit having the focal length variable.

### BRIEF DESCRIPTION OF THE DRAWINGS

FIG. 1 is an explanatory diagram illustrating an outline of a dielectric anisotropy of a liquid crystal.

FIG. 2 is an explanatory diagram illustrating an outline of a refractive index anisotropy of a liquid crystal.

FIG. 3 is a block diagram illustrating an outline of a spatial light modulator of phase modulation type.

FIG. 4 is a block diagram schematically illustrating a first configuration example of a beam shaping device according to a comparative example.

FIG. 5 is a block diagram schematically illustrating a second configuration example of a beam shaping device according to a comparative example.

FIG. 6 is a block diagram schematically illustrating a configuration example of a beam shaping device according to one embodiment of the present disclosure.

FIG. 7 is an explanatory diagram schematically illustrating operation of a varifocal lens in the beam shaping device according to one embodiment.

FIG. 8 is an explanatory diagram schematically illustrating an example of a machining method using the beam shaping device according to one embodiment.

FIG. 9 is an explanatory diagram schematically illustrating an example of a machining method using the beam shaping device according to one embodiment.

FIG. 10 is a block diagram schematically illustrating a configuration example of a beam shaping device according to Modification Example 1.

FIG. 11 is a block diagram schematically illustrating a configuration example of a beam shaping device according to Modification Example 2.

FIG. 12 is a block diagram schematically illustrating a configuration example of a beam shaping device according to Modification Example 3.

FIG. 13 is a block diagram schematically illustrating a configuration example of a beam shaping device according to Modification Example 4.

FIG. 14 is a block diagram schematically illustrating a configuration example of a beam shaping device according to Modification Example 5.

FIG. 15 is a block diagram schematically illustrating a configuration example of a beam shaping device according to Modification Example 6.

FIG. 16 is a block diagram schematically illustrating a configuration example of a beam shaping device according to Modification Example 7.

FIG. 17 is a block diagram schematically illustrating a first configuration example of a beam shaping device according to Modification Example 8.

FIG. 18 is a block diagram schematically illustrating a second configuration example of the beam shaping device according to Modification Example 8.

FIG. 19 is a block diagram schematically illustrating a configuration example of a beam shaping device according to Modification Example 9.

FIG. 20 is a block diagram schematically illustrating a configuration example of a beam shaping device according to Modification Example 10.

FIG. 21 is a block diagram schematically illustrating a configuration example of a beam shaping device according to Modification Example 11.

FIG. 22 is a block diagram schematically illustrating a configuration example of a beam shaping device according to Modification Example 12.

FIG. 23 is a block diagram schematically illustrating a configuration example of a beam shaping device according to Modification Example 13.

FIG. 24 is a block diagram schematically illustrating an example of application, to a machining device, of the beam shaping device according to one embodiment.

### MODES FOR CARRYING OUT THE INVENTION

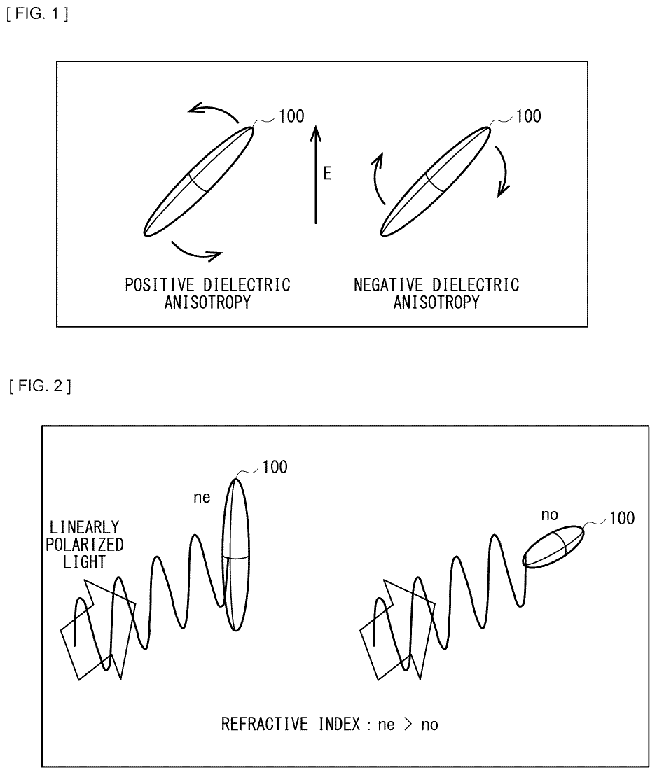

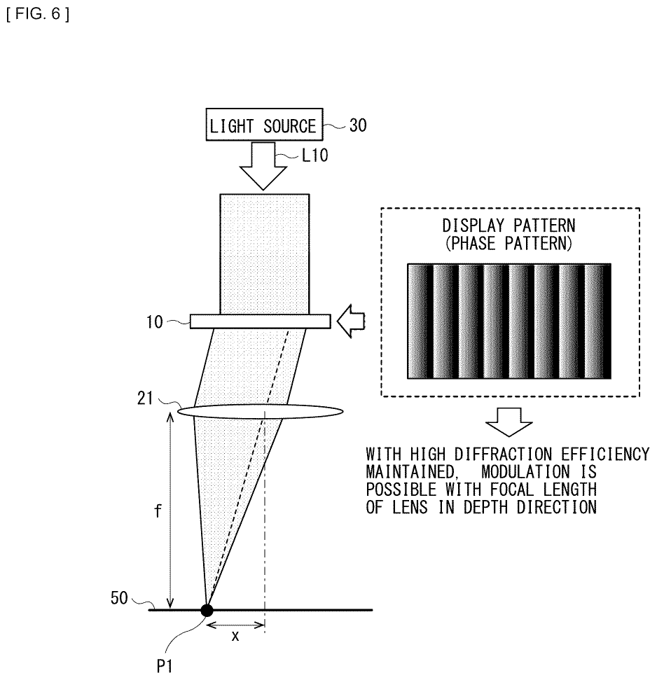

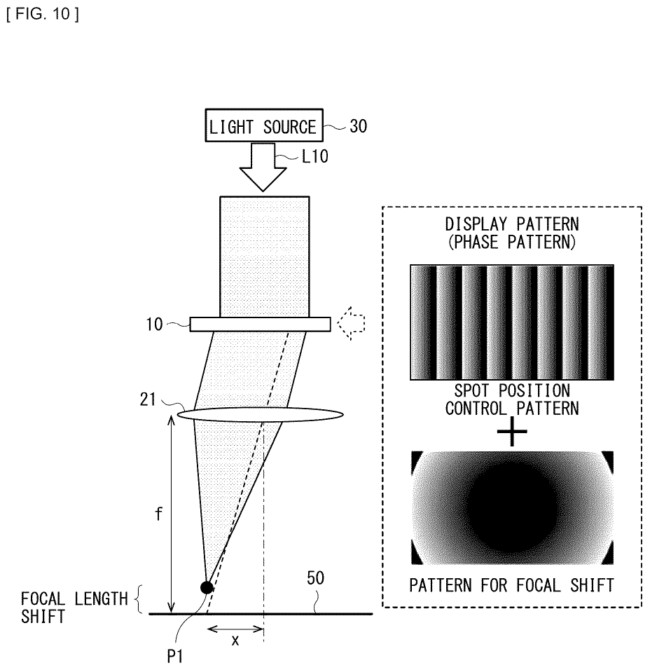

Hereinafter, embodiments of the present disclosure will be described in detail with reference to the drawings. Note that the description will be given in the following order.
0. Comparative Examples (FIGS. 1 to 5)
1. One Embodiment
   1.1 Basic Configuration and Operation (FIGS. 6 to 9)
   1.2 Modification Examples and Application Examples (FIGS. 10 to 24)
   1.3 Effects
2. Other Embodiments

### 0. Comparative Examples

### (Outline of Spatial Light Modulator (SLM) of Phase Modulation Type)

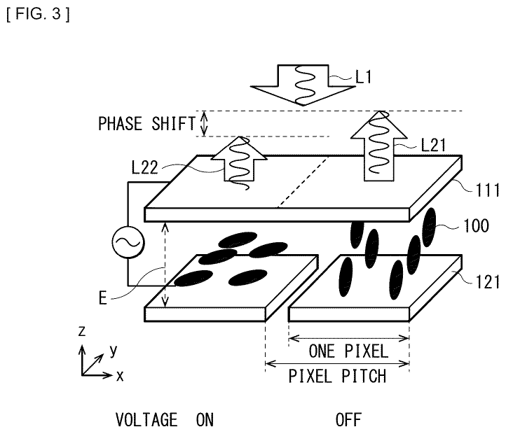

FIG. 1 illustrates an outline of a dielectric anisotropy of a liquid crystal. FIG. 2 illustrates an outline of a refractive index anisotropy of a liquid crystal. FIG. 3 illustrates an outline of a spatial light modulator of phase modulation type.

A liquid crystal has a dielectric anisotropy. As illustrated in FIG. 1, when an electric field E is applied to a liquid crystal molecule 100, one with the major axis parallel to the electric field direction is referred to as a positive dielectric anisotropy, and one with the minor axis parallel to the electric field direction is referred to as a negative dielectric anisotropy. Further, the liquid crystal has a refractive index anisotropy that the refractive index varies depending on the direction of the liquid crystal molecule 100. As illustrated in FIG. 2, assuming that a refractive index in a direction parallel to the major axis of the liquid crystal molecule 100 is denoted by ne and a refractive index in a direction parallel to the minor axis of the liquid crystal molecule 100 is denoted by no, ne>no, and the difference between the refractive index ne and the refractive index no is referred to as a refractive index anisotropy Δn (=ne−no). Such a refractive index anisotropy causes a phase difference in light depending on the incident direction.

A spatial light modulator of phase modulation type is a device that modulates only a phase of light by using the characteristics described above in liquid crystals. FIG. 3 illustrates a configuration example of a spatial light modulator of reflection type.

The spatial light modulator has a structure that includes a common electrode 111 and a pixel electrode 121 opposed to each other and that includes a liquid crystal layer including the liquid crystal molecules 100 between the common electrode 111 and the pixel electrode 121. The common electrode 111 is a transparent electrode, and has a surface on the liquid crystal layer side with an orientation film formed. The pixel electrode 121 has a surface on the liquid crystal layer side with a reflection film and an orientation film formed.

The liquid crystal molecules 100 have a pretilt angle applied. In a (voltage OFF) state that no voltage is applied between the common electrode 111 and the pixel electrode 121, the liquid crystal molecules 100 are in a standing state at the pretilt angle. As a voltage is applied between the common electrode 111 and the pixel electrode 121 (voltage ON), the liquid crystal molecules 100 tilt. Thus, a phase difference is caused between reflected light L21 from the pixel electrode 121 in the state of voltage OFF and reflected light L22 from the pixel electrode 121 in the state of voltage ON, because of the difference in state of the liquid crystal molecules 100 when light passes therethrough. With this, the spatial light modulator allows a phase of incident light LI to be controlled in an analog manner by controlling a voltage to be applied to the liquid crystal layer.

### (Outline of Beam Shaping Device Using Spatial Light Modulator of Phase Modulation Type and Issues)

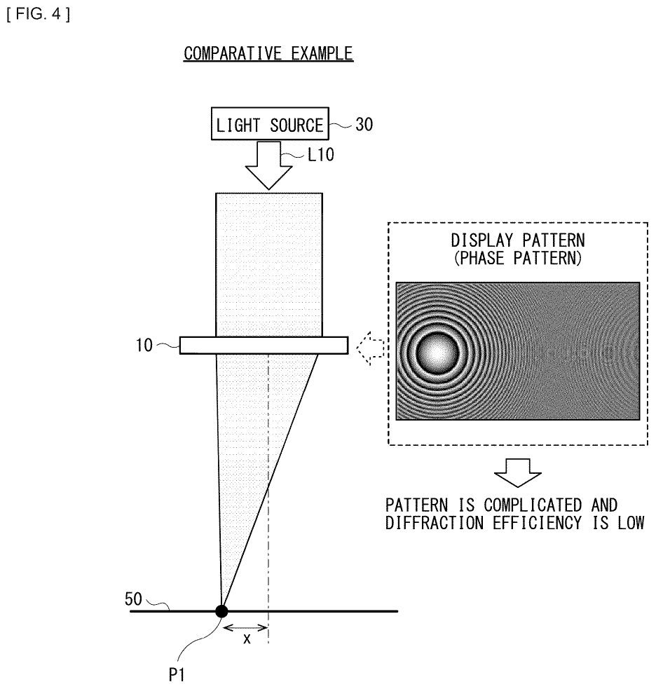

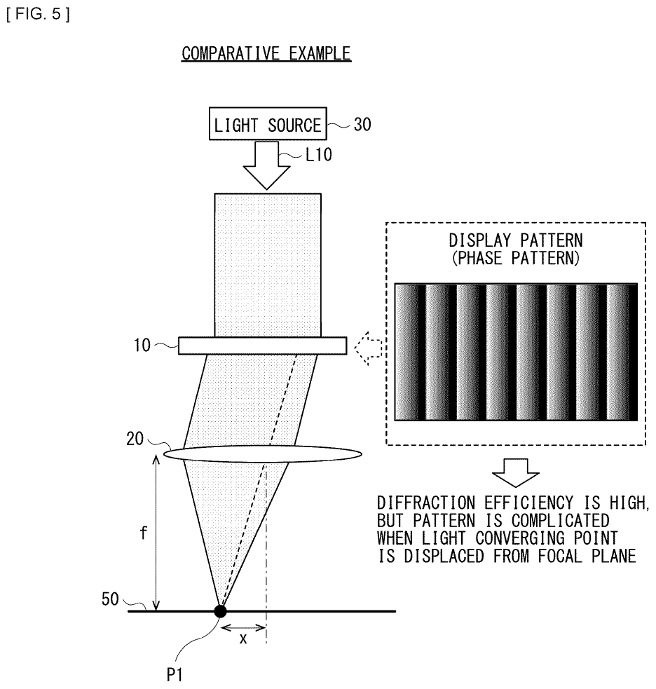

FIG. 4 schematically illustrates a first configuration example of a beam shaping device according to a comparative example. FIG. 5 schematically illustrates a second configuration example of a beam shaping device according to a comparative example.

In recent years, in the field of beam shaping or machining equipment, enhancement in performance is expected with application of a spatial light modulator of phase modulation type. A first method of using a spatial light modulator is a method that light distribution obtained by modulating a phase of incident light L10 from a light source 30 by a spatial light modulator 10 is, as it is, applied to an irradiation target surface 50 (object to be machined or the like) as an irradiation pattern, as illustrated in FIG. 4. The spatial light modulator 10 displays, as a display pattern, a phase pattern corresponding to the irradiation pattern to be applied to the object. In the first method, a light converging spot point P1 is formed on the irradiation target surface 50 only by the spatial light modulator 10. At that time, only by changing the phase pattern displayed on the spatial light modulator 10, a distance x from the center of an irradiation region is changed for change of an irradiation range. Thus, the phase pattern displayed on the spatial light modulator 10 is complicated and the diffraction efficiency is low.

Further, a second method is a method that the phase of the incident light L10 from the light source 30 is modulated by the spatial light modulator 10, and then the light converging spot point P1 is formed on the irradiation target surface 50 through a Fourier transformation lens 20 having a focal length fixed. In the second method, the position in surface (the distance x from the center of the irradiation region) of the light converging spot point P1 and two-dimensional distribution are controlled by the spatial light modulator 10. In the first method, the phase pattern displayed on the spatial light modulator 10 is complicated and the diffraction efficiency is low. In contrast, in the second method, light is converged by converging capability of the Fourier transformation lens 20, and thus an advantage is provided in that light is possible to be converged on a fine spot efficiently, on the other hand, when the light converging point is displaced from the focal plane, the phase pattern is made complicated and the diffraction efficiency is lowered.

In practice, the spatial light modulator 10 is utilized in dicing of silicon wafers. In such a utilization, laser light is converged inside a wafer to form a modified layer and the wafer is cut. The spatial light modulator 10 has a role of correcting an aberration generated in a base material. As the example described above, since machining using such an existing spatial light modulator 10 is limited to forming of a simple light converging point, it is sufficient, in the second method described above, that the Fourier transformation lens 20 has a focal point at a focal length f for a desired spot size to be obtained. On the other hand, the spatial light modulator 10 is configured to form any light two-dimensional distribution, allowing achievement of machining or welding of more complicated shapes to be expected. Complicated shapes refer to machined points distributed in a depth direction or machining of different sizes mixed. In a case of applying the spatial light modulator 10 to machining of more complicated, a fact that the focal point of the Fourier transformation lens 20 is fixed causes the degree of freedom in machining to be lowered.

In a case where the Fourier transformation lens 20 of fixed-focus is used, the minimum spot size and the irradiation range are fixed, and thus it is difficult to meet a variety of needs in irradiation shapes. Further, the position of the light converging spot point P1 in the depth direction is fixed with the focal length f (FIG. 5). Although the light converging spot point P1 is possible to be shifted around the focal length f by superposing a phase pattern of lens shape, such as a Fresnel lens pattern, on the spatial light modulator 10, the longer the distance from the focal plane the finer the Fresnel lens pattern displayed on the spatial light modulator 10, and thus the diffraction efficiency is lowered.

With beam shaping by the spatial light modulator 10 as in the first method and second method described above, in a utilization such as machining, it is difficult to meet all needs in irradiation shapes. Further, when the focal point is greatly shifted in the depth direction only by the phase pattern displayed on the spatial light modulator 10, the diffraction efficiency is lowered, decreasing the light intensity of the light converging spot point P1.

In Patent Literature 1 (Japanese Unexamined Patent Application Publication No. 2006-119427), a laser machining method is proposed that, in phase modulating of light emitted from a laser light source with a spatial light modulator of phase modulation type, a phase distribution for positional shift is superposed on input data. Further, in Patent Literature 2 (Japanese Unexamined Patent Application Publication No. 2016-75810), it is proposed to achieve shifting of an irradiation position of vessel light by superposing a phase distribution for shifting of a light converging point on a phase distribution forming vessel light on a spatial light modulator.

In the optical systems proposed in Patent Literature 1 and 2, however, when a phase pattern for focal shift is displayed on the spatial light modulator, a spatial frequency of the phase pattern rises, lowering the diffraction efficiency. In contrast, in a technique of the present disclosure, a focal point is possible to be shifted in the depth direction by an optical unit having a focal length f variable, allowing a fall in diffraction efficiency to be suppressed.

### 1. One Embodiment

### [1.1 Basic Configuration and Operation] (Outline)

FIG. 6 schematically illustrates a configuration example of a beam shaping device according to one embodiment of the present disclosure.

The beam shaping device according to one embodiment includes a spatial light modulator 10 of phase modulation type and a varifocal lens 21 as the optical unit having the focal length f variable.

The spatial light modulator 10 modulates a phase of incident light L10 and thereby displays, as a display pattern, a phase pattern corresponding to an irradiation pattern to be applied to an irradiation target surface 50 (a surface to be machined, an object to be machined or the like). On the irradiation target surface 50, the spatial light modulator 10 forms, as the irradiation pattern, a hologram with one or more light converging spot points P1 formed, for example. As the incident light L10, light from a light source 30 having a certain degree of coherency enters the spatial light modulator 10. The light source 30 may include, a laser light source of course, a light emitting diode (LED) having a certain degree of spatial coherency. The spatial light modulator 10 modulates a phase of light from the light source 30 and thus allows any shapes to be formed by interference of light or allows a traveling direction of light to be modulated. The spatial light modulator 10 includes a pixel array in two dimensions. The spatial light modulator 10 may be of reflection type or transmission type.

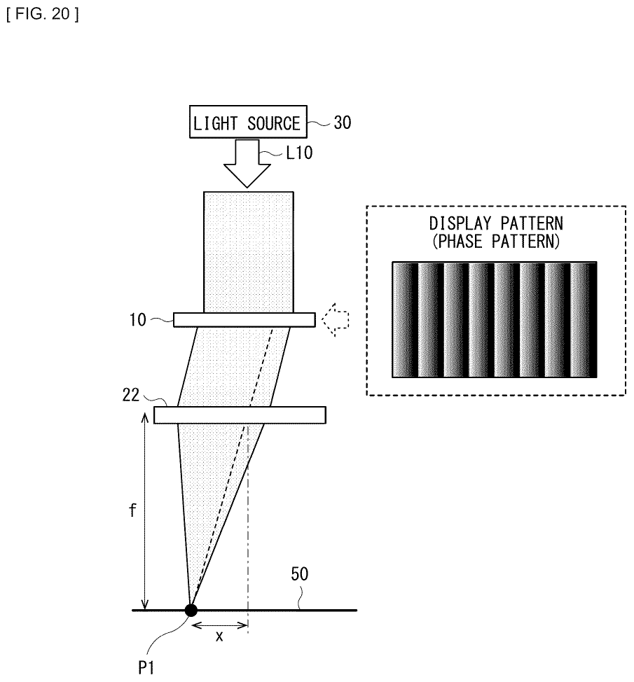

The varifocal lens 21 converges light modulated by the spatial light modulator 10 on the object to form the light converging spot point P1 on the irradiation target surface 50. The varifocal lens 21 may include a liquid crystal lens 22, a revolver-type varifocal lens 24, and a liquid lens 25, as illustrated in Modification Examples (FIGS. 20 to 23) below. Further, the varifocal lens 21 may include a spatial light modulator 23 of phase modulation type disposed separately from the spatial light modulator 10 forming the irradiation pattern.

As the spatial frequency of the phase pattern displayed on the spatial light modulator 10 rises, the diffraction efficiency is lowered. In the beam shaping device according to one embodiment, the combination of the spatial light modulator 10 and the varifocal lens 21 makes it possible to lower the spatial frequency of the phase pattern displayed on the spatial light modulator 10, suppressing a fall in diffraction efficiency.

In the beam shaping device according to one embodiment, the varifocal lens 21 is in charge of focal shift in the depth direction, allowing the spatial frequency of the phase pattern displayed on the spatial light modulator 10 to be lowered. The focal point is possible to be modulated by the varifocal lens 21, and this makes it possible to control a combination of a range for the light converging spot point P1 to be able to be formed and a resolution.

In the beam shaping device according to one embodiment, as compared with the configuration of the beam shaping device according to the comparative example (FIG. 5), the varifocal lens 21 is used instead of the Fourier transformation lens 20 having the focal length fixed, allowing a function of shifting the focal plane to be achieved by the varifocal lens 21. This makes it possible to suppress the spatial frequency of the phase pattern displayed on the spatial light modulator 10. This allows the focal plane to be changed remaining a high diffraction efficiency achieved.

### (Optical Resolution and Irradiatable Range)

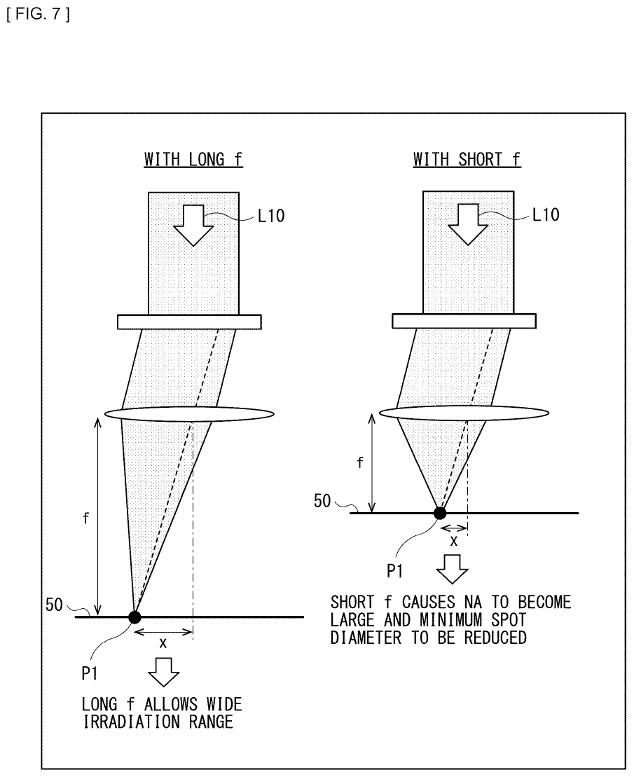

FIG. 7 schematically illustrates operation of the varifocal lens 21 in the beam shaping device according to one embodiment.

In the beam shaping device, in a case where the focal length f is modulatable by the varifocal lens 21, an optical resolution in laser shaping and an irradiatable range for light are possible to be changed. For example, in a case where the incident light L10 is a Gaussian beam, a minimum light converging spot diameter ωₘᵢₙ, calculated using a diameter D of the beam the varifocal lens 21 is irradiated with and the focal length f, is ωmin=4λf/πD. Note that, λ is a wavelength of the incident light L10. Since the shorter the focal length f the larger the NA, the spot diameter is possible to be made small.

Further, the range for the light converging spot point P1 to be able to be formed is expressed by the following expression.

xₘₐₓ=f·tanθₘₐₓ

Note that θₘₐₓ is a maximum angle of diffraction of the spatial light modulator 10. This expression shows that the longer the focal length f the larger the irradiatable range.

The light converging spot diameter and the irradiatable range for light are in a trade-off relation. Although such a relation is difficult to be solved, use of the varifocal lens 21 allows either a desired light converging spot diameter or a desired irradiatable range to be achieved depending on a situation. Such a function is possible to be dealt with, for example in machining where different sizes of machined patterns are mixed, by performing machining with making change in the focal length f depending on how large the machined patterns are.

### (Method of Controlling Spatial Light Modulator 10 and Varifocal Lens 21)

In a case where the spatial light modulator 10 and the varifocal lens 21 are combined, depending on an order of controls, the throughput is possible to be maximized for a machining utilization, for example.

Functions of the varifocal lens 21 in a view point of the machining utilization includes a function of modulating a position in the depth direction for a machined pattern to be formed and a function of modulating the size of the machined pattern and the optical resolution. In a case where an object to be machined has a three-dimensional shape or has different sizes in machined shapes, machining is to be processed with making changes in the focal length f of the varifocal lens 21 during the machining. In general, a driving speed of the varifocal lens 21 is slower than a driving speed of the spatial light modulator 10. Thus, decreasing the number of times of switching the focal length f of the varifocal lens 21 allows the machining throughput to be maximized.

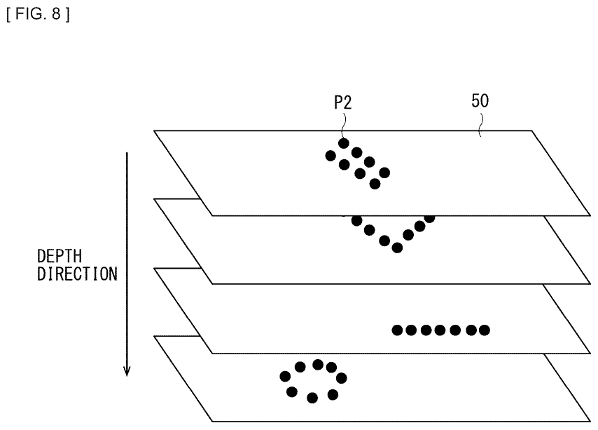

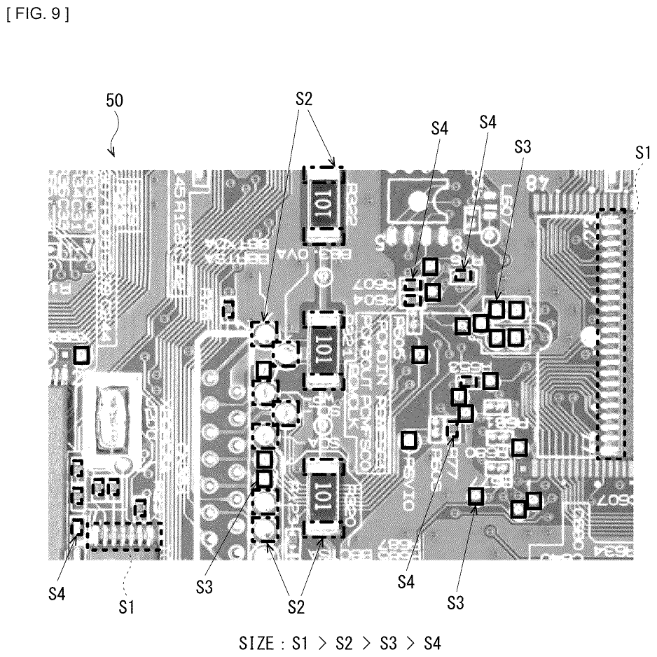

FIGS. 8 and 9 each schematically illustrate an example of a machining method using the beam shaping device according to one embodiment.

As illustrated in FIG. 8, in a case where machined points P2 are distributed in the depth direction, machined points P2 in a same depth are processed successively, allowing the throughput to be maximized. In other words, machined points P2 in a certain depth are all processed, and then, with the focal length f being switched successively, machined points P2 in another depth are processed successively, allowing the number of times of switching the focal length f of the varifocal lens 21 to be reduced and allowing the throughput to be maximized.

Further, as illustrated in FIG. 9, in a case where objects to be machined, in a same surface, have a variety of different machined sizes, machining is performed with the objects classified into ones by equivalent sizes, allowing the throughput to be maximized. For example, in FIG. 9, in a case where objects to be machined includes objects S1 each having an equivalent size, objects S2 each having an equivalent size, objects S3 each having an equivalent size, and objects S4 each having an equivalent size, and the respective sizes are in a relation of S1>S2>S3>S4, the focal point is determined for the respective sizes of the objects to be machined, and the objects in each size are machined together, allowing the number of times of switching the focal length f of the varifocal lens 21 to be reduced and allowing the throughput to be maximized.

### 1.2 Modification Examples and Application Examples

### Modification Example 1

FIG. 10 schematically illustrates a configuration example of a beam shaping device according to Modification Example 1.

In the beam shaping device according to Modification Example 1, the spatial light modulator 10 displays, as a phase pattern, a pattern obtained by superposing a pattern for focal shift that shifts a focal position by the varifocal lens 21 in the vertical direction (depth direction) on a pattern (spot position control pattern) corresponding to the irradiation pattern.

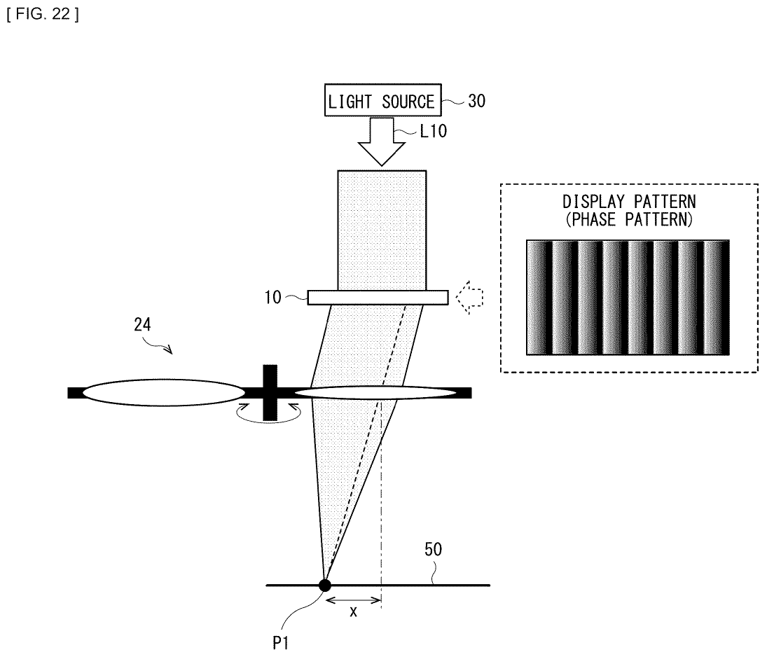

For the phase pattern, the spatial light modulator 10 superposes the pattern for focal shift in a degree for the diffraction efficiency not to be lowered, and thus the focal point of the varifocal lens 21 is possible to be shifted in the depth direction. Moreover, the 0 order diffracted light on the irradiation target surface 50 is defocused, allowing the object to be prevented from being machined on the light converging point of the 0 order diffracted light. Further, for example, in a case where the varifocal lens 21 is replaced with the revolver-type varifocal lens 24 described below (FIG. 22), the focal length f that is variable is intermittent. In such a case, in a case where light is intended to be converged at a position of a focal length f not included in the revolver, a pattern of a lens corresponding to the focal length f not included in the revolver-type varifocal lens 24 is superposed, for the phase pattern, on the spatial light modulator 10, allowing the focal length f not included in the revolver-type varifocal lens 24 to be supported.

The configuration and operation may be otherwise substantially similar to the configuration (FIG. 6) of the beam shaping device according to one embodiment described above.

### Modification Example 2

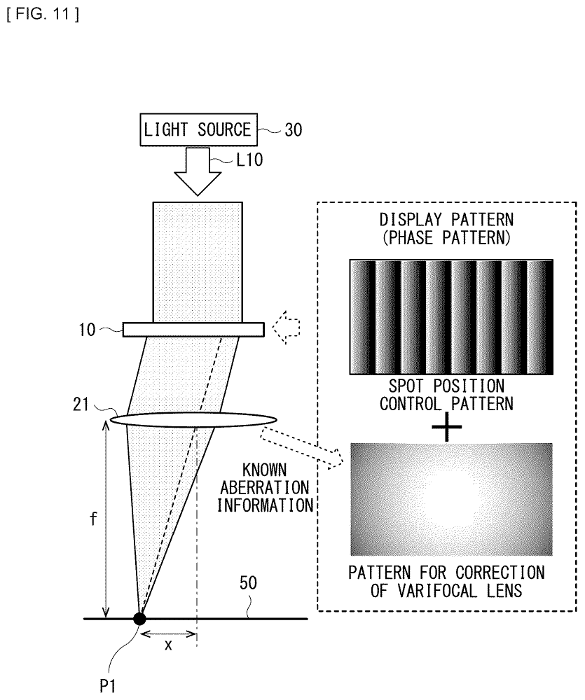

FIG. 11 schematically illustrates a configuration example of a beam shaping device according to Modification Example 2.

In the beam shaping device according to Modification Example 2, the spatial light modulator 10 displays, as a phase pattern, a pattern obtained by superposing a pattern for correction that corrects an aberration generated by the varifocal lens 21 on a pattern (spot position control pattern) corresponding to the irradiation pattern.

In general, the varifocal lens 21 has an aberration. In a case where the aberration is already known, for the phase pattern, a pattern for correction that corrects the aberration is superposed, and thereby the aberration generated by the varifocal lens 21 is possible to be compensated by the pattern for correction displayed on the spatial light modulator 10, allowing the light converging spot diameter to be minimized. This allows the resolution of the light converging spot point P1 to be enhanced.

The configuration and operation may be otherwise substantially similar to the configuration (FIG. 6) of the beam shaping device according to one embodiment described above.

### Modification Example 3

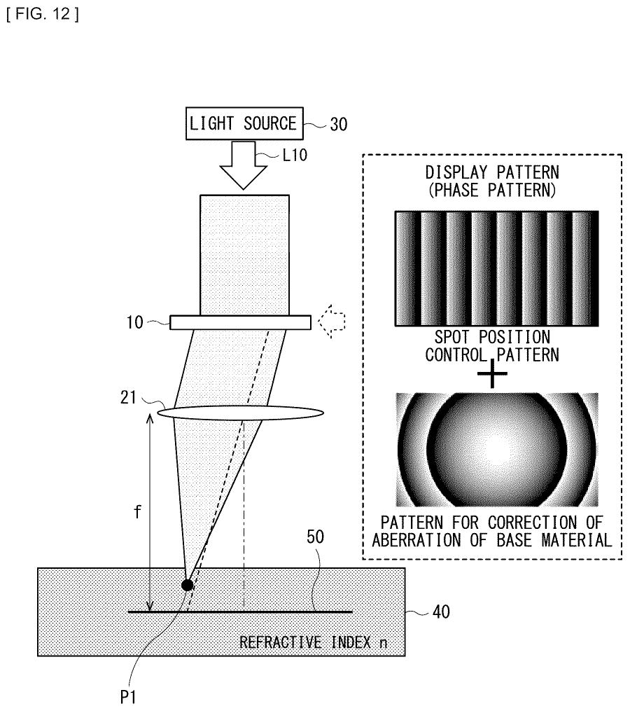

FIG. 12 schematically illustrates a configuration example of a beam shaping device according to Modification Example 3.

In the beam shaping device according to Modification Example 3, the spatial light modulator 10 displays, as a phase pattern, a pattern obtained by superposing a pattern for correction that corrects an aberration generated by a base material 40 of the irradiation target surface 50 (object to be machined or the like) on a pattern (spot position control pattern) corresponding to the irradiation pattern.

In a case where the irradiation target surface 50 inside the base material 40 having a thickness with a refractive index n is machined, convergent light propagates in the base material 40, causing an aberration. For correction of such an aberration, a pattern for correction corresponding to the refractive index n of the base material 40 and the thickness of the base material 40 is superposed on the pattern corresponding to the irradiation pattern, allowing the light converging spot diameter to be minimized even inside the base material 40. This allows the resolution of the light converging spot point P1 to be enhanced.

The configuration and operation may be otherwise substantially similar to the configuration (FIG. 6) of the beam shaping device according to one embodiment described above.

### Modification Example 4

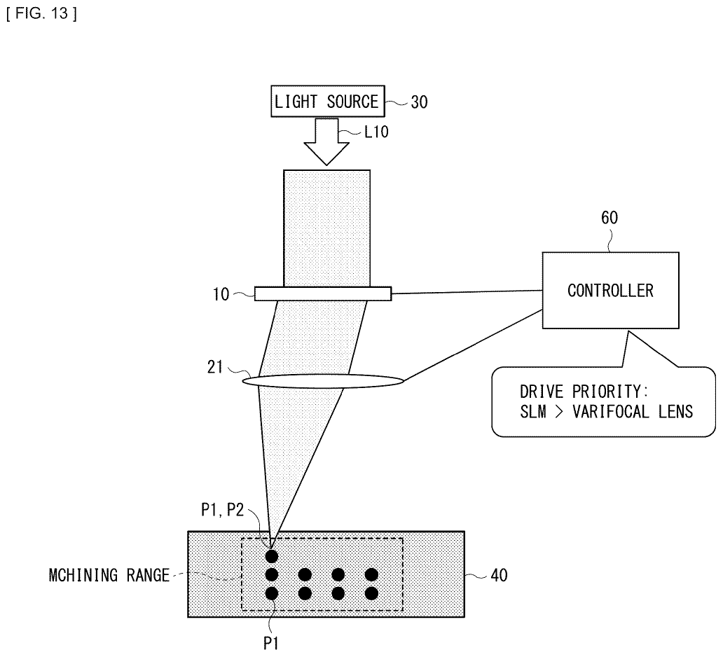

FIG. 13 schematically illustrates a configuration example of a beam shaping device according to Modification Example 4.

The beam shaping device according to Modification Example 4 further includes a controller 60 that performs control of switching the phase pattern to be displayed on the spatial light modulator 10 and control of switching the focal length f of the varifocal lens 21. The controller 60 performs control of prioritizing the control of switching the phase pattern to be displayed on the spatial light modulator 10 as compared with the control of switching the focal length f of the varifocal lens 21.

In general, the driving speed of the spatial light modulator 10 is faster than the driving speed of the varifocal lens 21, and thus “time for switching of the phase pattern to be displayed on the spatial light modulator 10<time for focal shift (time for switching of the focal length f)”. Thus, driving of the spatial light modulator 10 is prioritized and every phase pattern of the spatial light modulator 10 for a certain focal length f is changed, and then the focal length f is changed, allowing the number of driving times of the varifocal lens 21 to be reduced and allowing the overall throughput to be maximized. This is effective in a case where there is a plurality of machined points P2 in a horizontal surface and the depth direction of the base material 40 with the machined points P2 in a hierarchical state, as illustrated in FIG. 13, for example. For example, in order to machine the machined points P2 in the respective hierarchical surfaces, in a case where a plurality of phase patterns 1, 2, . . . n is to be displayed on the spatial light modulator 10 for the respective hierarchical surfaces with making switching of the focal length to f1, f2, . . . fm, control of switching is performed in an order as follows.

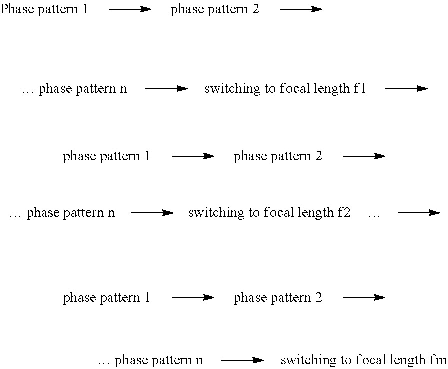

The configuration and operation may be otherwise substantially similar to the configuration (FIG. 6) of the beam shaping device according to one embodiment described above.

### Modification Example 5

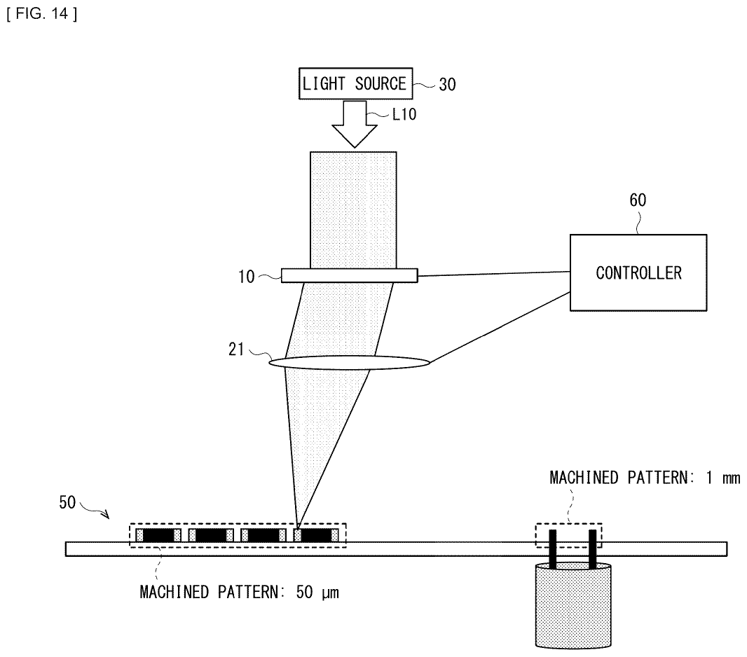

FIG. 14 schematically illustrates a configuration example of a beam shaping device according to Modification Example 5.

In a configuration of the beam shaping device according to Modification Example 5, similarly to the beam shaping device according to Modification Example 4, a controller 60 is further included that performs control of switching the phase pattern to be displayed on the spatial light modulator 10 and control of switching the focal length f of the varifocal lens 21. The controller 60 performs control of prioritizing the control of switching the phase pattern to be displayed on the spatial light modulator 10 as compared with the control of switching the focal length f of the varifocal lens 21.

In Modification Example 4 (FIG. 13), an example is illustrated that control of switching the focal length f of the varifocal lens 21 is performed in order to machine the machined points P2 provided at positions different in depth. Meanwhile, also in a case where there is a plurality of objects to be machined, in a same surface, having different machined sizes, control of switching the focal length f may be performed. In such a case, machined patterns of a certain size are all processed, and then the focal length f is changed, allowing the number of times of switching the focal length f of the varifocal lens 21 to be reduced and allowing the throughput to be maximized. FIG. 14 illustrates an example of a case where there are machined patterns of 50 μm and machined patterns of 1 mm on the same irradiation target surface 50 and the focal length f is to be switched between the machined patterns of 50 μm and the machined patterns of 1 mm. For example, in order to machine, on the same irradiation target surface 50, machined patterns having a plurality of sizes, in a case where the focal length is to be switched to f1, f2, . . . fm, control of switching is performed in an order as follows.

For example,

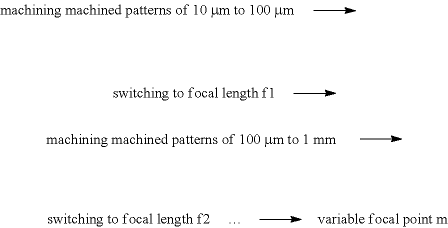

The configuration and operation may be otherwise substantially similar to the configuration (FIG. 6) of the beam shaping device according to one embodiment described above.

### Modification Example 6

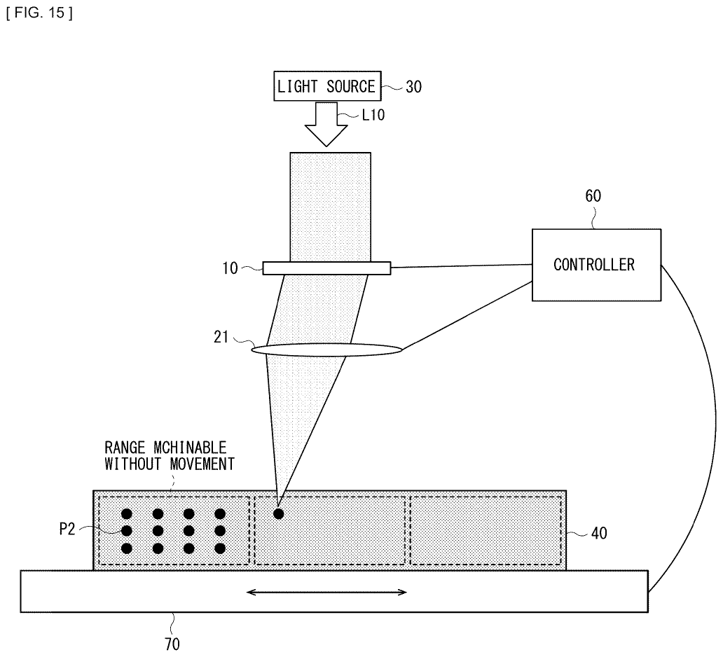

FIG. 15 schematically illustrates a configuration example of a beam shaping device according to Modification Example 6.

The beam shaping device according to Modification Example 6 further includes an XY stage 70 as a horizontal movement unit configured to move an object in a horizontal direction (XY direction). Further, the beam shaping device according to Modification Example 6 further includes a controller 60 that performs control of switching the phase pattern to be displayed on the spatial light modulator 10, control of switching the focal length f of the varifocal lens 21, and control of movement of the XY stage 70.

A range where the light converging spot point P1 is possible to be shifted by the spatial light modulator 10 is limited by the maximum angle of diffraction of the spatial light modulator 10. The combination of the spatial light modulator 10 and the XY stage 70 makes it possible to machine a large area while moving the object to be machined, allowing the machined area to be enhanced.

The configuration and operation may be otherwise substantially similar to the configuration (FIG. 6) of the beam shaping device according to one embodiment described above.

### Modification Example 7

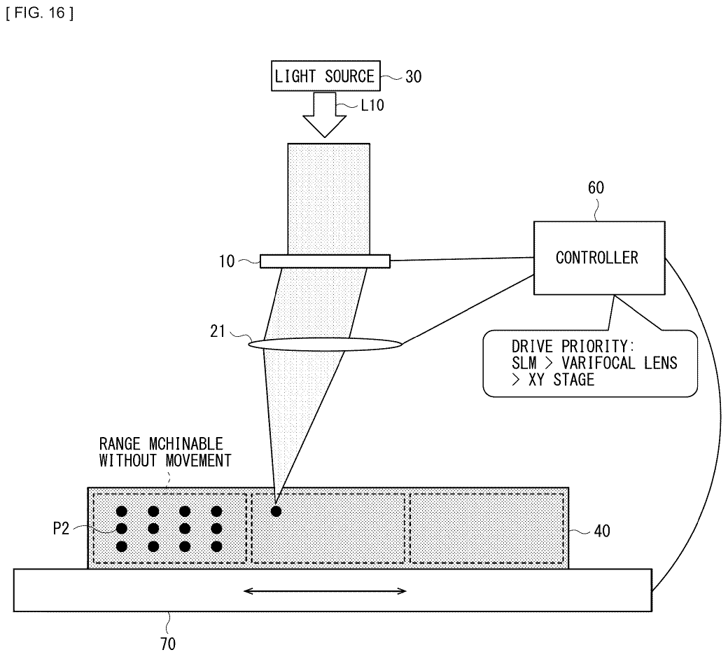

FIG. 16 schematically illustrates a configuration example of a beam shaping device according to Modification Example 7.

The beam shaping device according to Modification Example 7 further includes, similarly to the beam shaping device according to Modification Example 6, an XY stage 70 as the horizontal movement unit configured to move an object in the horizontal direction (XY direction). The beam shaping device according to Modification Example 7 further includes, similarly to the beam shaping device according to Modification Example 6, a controller 60 that performs control of switching the phase pattern to be displayed on the spatial light modulator 10, control of switching the focal length f of the varifocal lens 21, and control of movement of the XY stage 70.

In the beam shaping device according to Modification Example 7, the controller 60 prioritizes the control of switching the phase pattern to be displayed on the spatial light modulator 10, the control of switching the focal length f of the varifocal lens 21, and the control of movement of the XY stage 70 in this order. In general, the spatial light modulator 10, the varifocal lens 21, and the XY stage 70 have higher driving speeds in this order, and thus “time for switching of the phase pattern to be displayed on the spatial light modulator 10<time for focal shift (time for switching of the focal length f)<driving time of the XY stage 70”. Thus, the control of switching the phase pattern to be displayed on the spatial light modulator 10, the control of switching the focal length f of the varifocal lens 21, and the control of movement of the XY stage 70 are prioritized in this order for driving, allowing the overall throughput to be maximized while enhancing the machined area. For example, as illustrated in FIG. 16, in a case where there is a plurality of machined points P2 in the horizontal surface and the depth direction of the base material 40 with the machined points P2 in a hierarchical state, in order to machine the machined points P2 in the respective hierarchical surfaces, when a plurality of phase patterns 1, 2, . . . n is to be displayed on the spatial light modulator 10 for the respective hierarchical surfaces with making switching of the focal length to f1, f2, . . . fm, and further the base material 40 is to be moved by the XY stage 70, control of switching is performed in an order as follows.

For example,

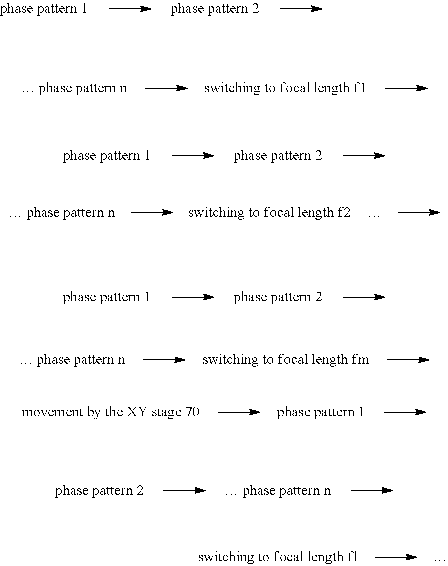

The configuration and operation may be otherwise substantially similar to the configuration (FIG. 6) of the beam shaping device according to one embodiment described above.

### Modification Example 8

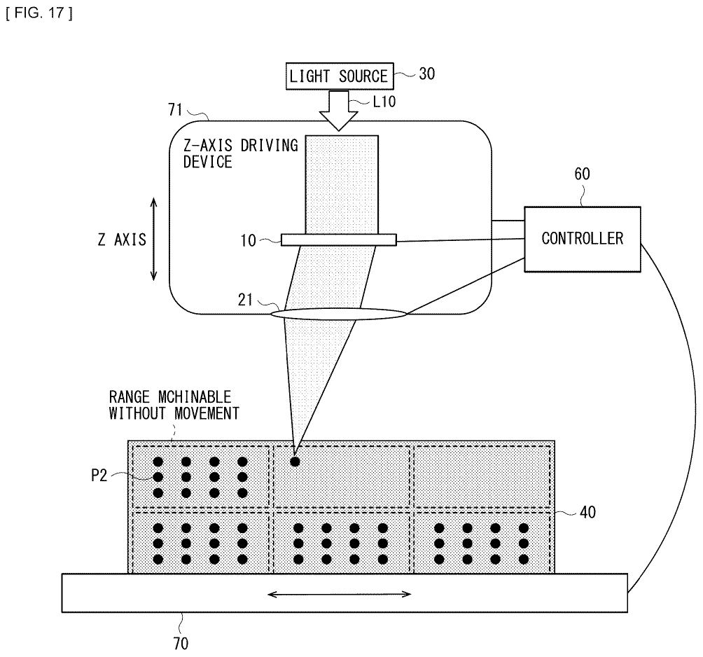

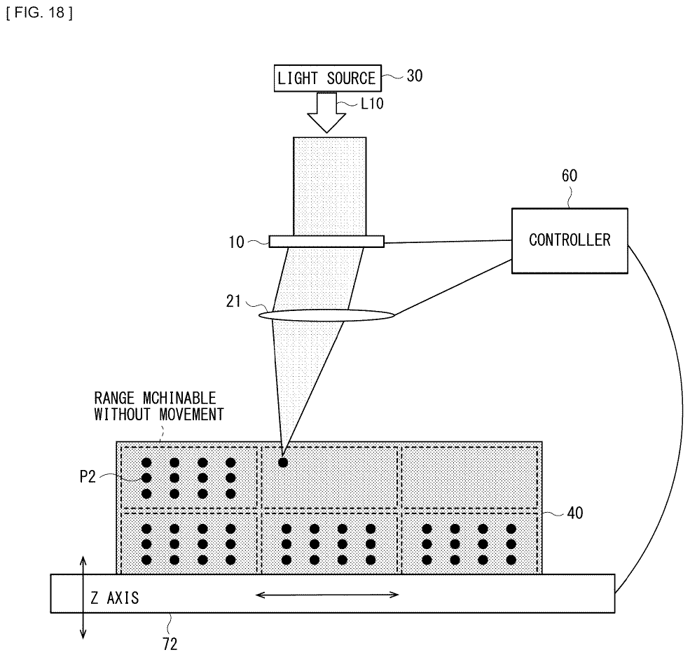

FIG. 17 schematically illustrates a first configuration example of a beam shaping device according to Modification Example 8. FIG. 18 schematically illustrates a second configuration example of the beam shaping device according to Modification Example 8.

The beam shaping device according to Modification Example 8 further includes a vertical movement unit that is configured to move an object or the spatial light modulator 10 and varifocal lens 21 in the vertical direction (Z-axis direction).

In the first configuration example illustrated in FIG. 17, an example is illustrated that the XY stage 70 as the horizontal movement unit configured to move the object in the horizontal direction (XY direction) and a Z-axis driving device 71 are included. The T Z-axis driving device 71 is a vertical movement unit configured to move the spatial light modulator 10 and the varifocal lens 21 in the vertical direction (Z-axis direction). Further, in the first configuration example illustrated in FIG. 17, a controller 60 is further included that performs control of switching the phase pattern to be displayed on the spatial light modulator 10, control of switching the focal length f of the varifocal lens 21, and control of movement of the Z-axis driving device 71 and XY stage 70.

In the second configuration example illustrated in FIG. 18, an example is illustrated that an XYZ stage 72 as the horizontal movement unit and vertical movement unit configured to move the object in the horizontal direction (XY direction) and the vertical direction (Z-axis direction) is included. Further, in the second configuration example illustrated in FIG. 18, a controller 60 is further included that performs control of switching the phase pattern to be displayed on the spatial light modulator 10, control of switching the focal length f of the varifocal lens 21, and control of movement of the XYZ stage 72.

In a case where the focal length f is changed by the varifocal lens 21, the irradiatable range for light and the optical resolution are also changed at the same time, but a change in machined voxel size in the depth direction may be troublesome for some utilizations. Further, in a case where a spot is shifted to a position much far from the focal length f of the varifocal lens 21, the diffraction efficiency is lowered. For such an issue, a unit configured to move an optical system in the Z-axis direction or a Z-axis stage is used and this makes it possible to change a distance between an object to be machined and the spatial light modulator 10 and varifocal lens 21, allowing the object to be machined to be machined remaining a high diffraction efficiency without changing the focal length f of the varifocal lens 21 so much. Further, this allows the degree of freedom in the irradiatable range for light and the resolution to be enhanced.

The configuration and operation may be otherwise substantially similar to the configuration (FIG. 6) of the beam shaping device according to one embodiment described above.

### Modification Example 9

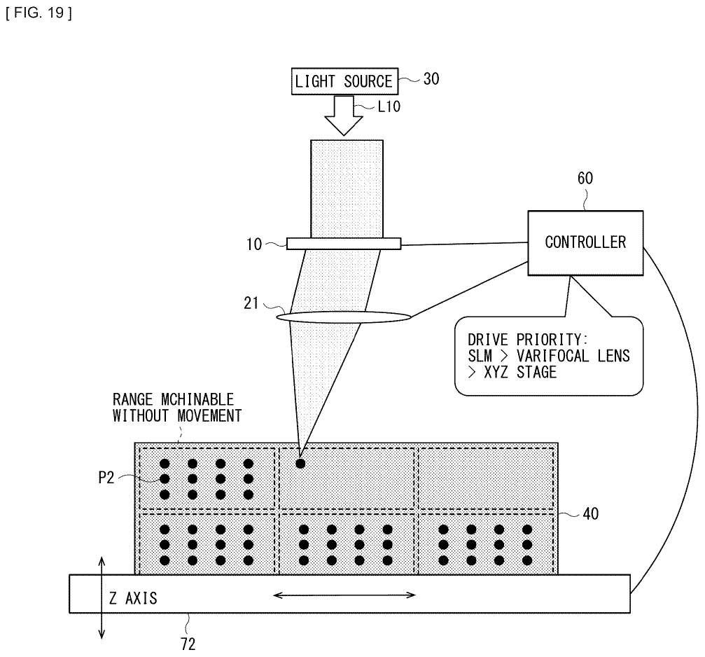

FIG. 19 schematically illustrates a configuration example of a beam shaping device according to Modification Example 9.

In the beam shaping device according to Modification Example 8 illustrated in FIGS. 17 and 18, the controller 60 may prioritize the control of switching the phase pattern to be displayed on the spatial light modulator 10, the control of switching the focal length f of the varifocal lens 21, and control of movement of the vertical movement unit in this order.

FIG. 19 illustrates a configuration example corresponding to the second configuration example of the beam shaping device according to Modification Example 8 illustrated in FIG. 18. Hereinafter, control in a case where the vertical movement unit is the XYZ state 72 is described as an example. In general, the spatial light modulator 10, the varifocal lens 21, and the XYZ stage 72 have higher driving speeds in this order, and thus “time for switching of the phase pattern to be displayed on the spatial light modulator 10<time for focal shift (time for switching of the focal length f)<driving time of the XYZ stage 72”. Thus, the control of switching the phase pattern to be displayed on the spatial light modulator 10, the control of switching the focal length f of the varifocal lens 21, and the control of movement of the XYZ stage 72 are prioritized in this order for driving, allowing the overall throughput to be maximized while enhancing the machined area. For example, as illustrated in FIG. 19, in a case where there is a plurality of machined points P2 in the horizontal surface and the depth direction of the base material 40 with the machined points P2 in a hierarchical state, in order to machine the machined points P2 in the respective hierarchical surfaces, when a plurality of phase patterns 1, 2, . . . n is to be displayed on the spatial light modulator 10 for the respective hierarchical surfaces with making switching of the focal length to f1, f2, . . . fm, and further the base material 40 is to be moved by the XYZ stage 72, control of switching is performed in an order as follows.

For example,

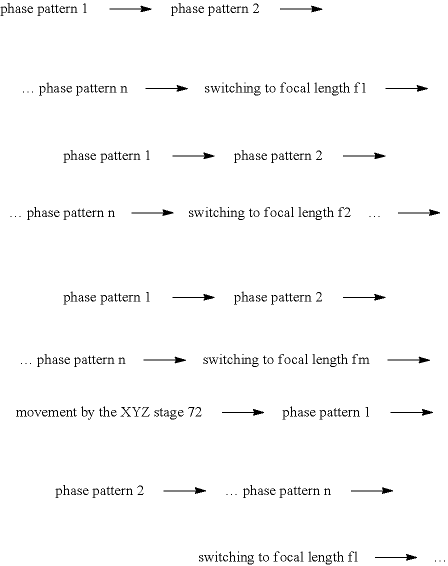

The configuration and operation may be otherwise substantially similar to the configuration (FIG. 6) of the beam shaping device according to one embodiment described above.

### Modification Example 10

FIG. 20 schematically illustrates a configuration example of a beam shaping device according to Modification Example 10.

The beam shaping device according to Modification Example 10 includes, as an optical unit having the focal length f variable, the liquid crystal lens 22 having the focal length f variable.

With the liquid crystal lens 22 used as the optical unit having the focal length f variable, the optical unit having the focal length f variable is possible to be made thinner, allowing the optical system to be reduced in its weight and size. Furthermore, the focal length f is possible to be adjusted continuously.

The configuration and operation may be otherwise substantially similar to the configuration (FIG. 6) of the beam shaping device according to one embodiment described above.

### Modification Example 11

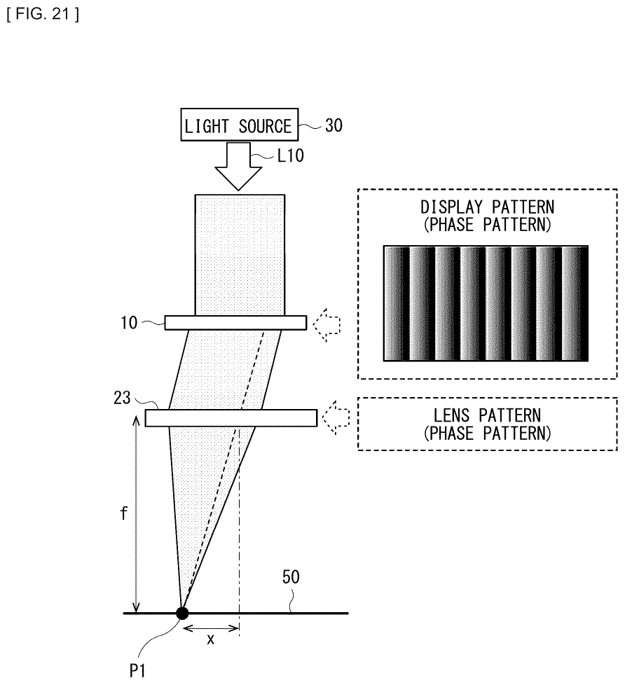

FIG. 21 schematically illustrates a configuration example of a beam shaping device according to Modification Example 11.

The beam shaping device according to Modification Example 11 includes, as an optical unit having the focal length f variable, the spatial light modulator 23 having the focal length f variable.

The spatial light modulator 10 displays, as a display pattern, a phase pattern corresponding to an irradiation pattern to be applied to an object. Meanwhile, the spatial light modulator 23 displays, as a phase pattern, a lens pattern for causing the spatial light modulator 23 to function as an optical unit having the focal length f variable. With the spatial light modulator 23 used as the optical unit having the focal length f variable, the optical unit having the focal length f variable is possible to be made thinner, allowing the optical system to be reduced in its weight and size. Furthermore, the focal length f is possible to be adjusted continuously.

Note that, although the liquid crystal lens 22 (FIG. 20) and the spatial light modulator 23 are the same in being configured to voltage drive a liquid crystal, an electrode shape of the liquid crystal lens 22 is, for example, in a circular shape for achievement of only a lens function. The spatial light modulator 23 includes a pixel array in a rectangular shape, for example. Note that, although a configuration of the liquid crystal lens 22 includes a configuration with Fresnel lenses combined and a configuration using a cholesteric liquid crystal, types of the liquid crystal lens 22 used as the optical unit having the focal length f variable are not limited to these.

The configuration and operation may be otherwise substantially similar to the configuration (FIG. 6) of the beam shaping device according to one embodiment described above.

### Modification Example 12

FIG. 22 schematically illustrates a configuration example of a beam shaping device according to Modification Example 12.

The beam shaping device according to Modification Example 12 includes, as an optical unit having the focal length f variable, a revolver-type variable focal length lens 24 with a plurality of lenses having different focal lengths f.

With the revolver-type variable focal length lens 24 used as the optical unit having the focal length f variable, a dioptric lens with design know-how stored therein is possible to be employed, allowing suppression of an aberration to be made easier. Note that, although focal adjustment is discrete in the revolver-type variable focal length lens 24, in a case where light is intended to be converged at a position of a focal length f not included in the revolver, a pattern of a lens corresponding to the focal length f not included in the revolver-type varifocal lens 24 is superposed, for the phase pattern, on the spatial light modulator 10, allowing the focal length f not included in the revolver-type varifocal lens 24 to be supported. In such a case, although it is anticipated that the spatial frequency of the phase pattern displayed on the spatial light modulator 10 rises and the diffraction efficiency is lowered, the spatial frequency of the phase pattern is possible to be lowered, as compared with the case of performing light modulation only by the spatial light modulator 10 (FIG. 4) or the case of using the Fourier transformation lens 20 of fixed-focus (FIG. 5), allowing the diffraction efficiency to be enhanced.

The configuration and operation may be otherwise substantially similar to the configuration (FIG. 6) of the beam shaping device according to one embodiment described above.

### Modification Example 13

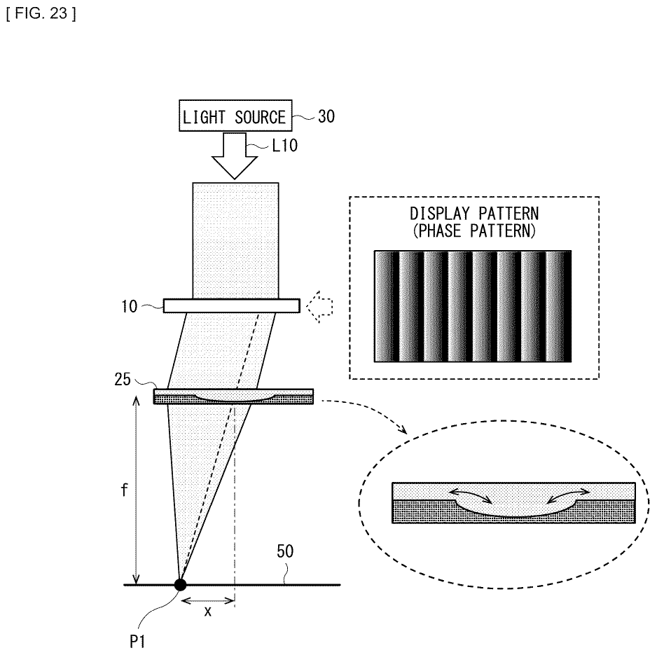

FIG. 23 schematically illustrates a configuration example of a beam shaping device according to Modification Example 13.

The beam shaping device according to Modification Example 10 includes, as an optical unit having the focal length f variable, the liquid lens 25 having the focal length f variable.

With the liquid lens 25 used as the optical unit having the focal length f variable, the focal length f is possible to be adjusted continuously.

The configuration and operation may be otherwise substantially similar to the configuration (FIG. 6) of the beam shaping device according to one embodiment described above.

### Application Examples

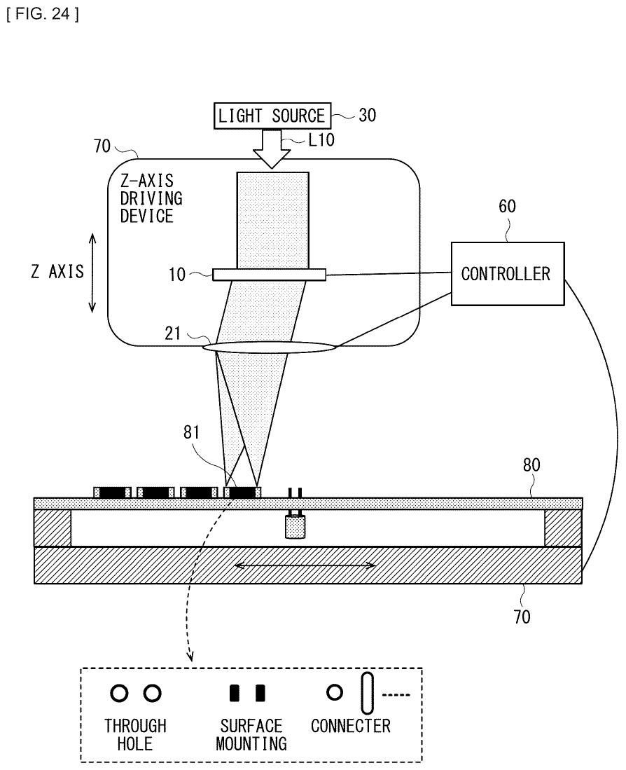

FIG. 24 illustrates an example of application, to a machining device, of the beam shaping device according to one embodiment. FIG. 24 illustrates a configuration example of a case where the beam shaping device according to Modification Example 8 illustrated in FIG. 17 is used as the beam shaping device.

The beam shaping device according to one embodiment is applicable to a machining device such as a laser soldering device, for example. FIG. 24 illustrates an example of a case where parts 81 having different sizes or shapes are soldered on an electronic circuit board 80. For example, the beam shaping device according to one embodiment constitutes a laser soldering device that the spatial light modulator 10 and the varifocal lens 21 are combined. In the soldering, the parts 81 have sizes that vary greatly from several tens of μm to several mm, and thus the resolution and the irradiation range for light that are desired differ depending on the types of the parts 81 to be soldered. In a case where a monofocal (fixed-focus) lens is used (FIG. 5), it is difficult to deal with the parts 81 having different sizes or shapes. With use of the varifocal lens 21, this makes it possible to deal with the parts 81 having different sizes or shapes.

The configuration and operation may be otherwise substantially similar to the configuration (FIG. 6) of the beam shaping device according to one embodiment described above.

### [1.3 Effects]

As described above, in the beam shaping device according to one embodiment, the spatial light modulator 10 displays a phase pattern corresponding to an irradiation pattern to be applied to an object, and the optical unit having the focal length f variable converges light modulated by the spatial light modulator 10 on the object. This allow wide range and high accuracy modulation of an irradiation pattern to be performed.

In the beam shaping device according to one embodiment, the combination of the spatial light modulator 10 and the varifocal lens 21 allows the degree of freedom in a focal spot size and in the irradiation range to be enhanced, allowing needs in a variety of irradiation shapes to be met. The varifocal lens 21 is in charge of focal shift in the depth direction, allowing a fall in diffraction efficiency to be suppressed. Further, in the beam shaping device according to one embodiment, the focal length f of the Fourier transformation lens is made variable, allowing the focal length f to be made long in a scene where a wide range of steering is to be performed while maintaining the diffraction efficiency, and allowing the focal length f to be made short in a scene where the optical resolution is desired.

Note that the effect described in this specification is only an example, which is not limited. Another effect may be present. This applies similarly to an effect of other embodiments below.

### 2. Other Embodiments

A technique of the present disclosure is not limited to the description of one embodiment described above, and is modifiable in a variety of ways for implementation.

For example, the present technique is possible to have a configuration as below.

According to the present technique having a configuration as below, the spatial light modulator displays a phase pattern corresponding to an irradiation pattern to be applied to an object, and the optical unit having the focal length f variable converges light modulated by the spatial light modulator on the object. This allow wide range and high accuracy modulation of an irradiation pattern to be performed.

(1)

A beam shaping device including:
a spatial light modulator of phase modulation type that displays a phase pattern corresponding to an irradiation pattern to be applied to an object; and
an optical unit that has a focal length variable and that converges light modulated by the spatial light modulator on the object.
   (2)

The beam shaping device according to (1), in which the spatial light modulator displays, as the phase pattern, a pattern obtained by superposing a pattern for focal shift that shifts a focal position by the optical unit in a vertical direction on a pattern corresponding to the irradiation pattern.

(3)

The beam shaping device according to (1) or (2), in which the spatial light modulator displays, as the phase pattern, a pattern obtained by superposing a pattern for correction that corrects an aberration generated by the optical unit on a pattern corresponding to the irradiation pattern.

(4)

The beam shaping device according to any one of (1) to (3), in which the spatial light modulator displays, as the phase pattern, a pattern obtained by superposing a pattern for correction that corrects an aberration generated by a base material of the object on a pattern corresponding to the irradiation pattern.

(5)

The beam shaping device according to any one of (1) to (4), further including a controller that performs control of switching the phase pattern to be displayed on the spatial light modulator and control of switching the focal length of the optical unit, in which
the controller performs control of prioritizing the control of switching the phase pattern to be displayed on the spatial light modulator as compared with the control of switching the focal length of the optical unit.
   (6)

The beam shaping device according to any one of (1) to (5), further including a horizontal movement unit configured to move the object in a horizontal direction.

(7)

The beam shaping device according to (6), further including a controller that performs control of switching the phase pattern to be displayed on the spatial light modulator, control of switching the focal length of the optical unit, and control of movement of the horizontal movement unit, in which the controller prioritizes the control of switching the phase pattern to be displayed on the spatial light modulator, the control of switching the focal length of the optical unit, and the control of movement of the horizontal movement unit in this order.

(8)

The beam shaping device according to any one of (1) to (7), further including a vertical movement unit that is configured to move the object or the spatial light modulator and the optical unit in a vertical direction.

(9)

The beam shaping device according to (8), further including a controller that performs control of switching the phase pattern to be displayed on the spatial light modulator, control of switching the focal length of the optical unit, and control of movement of the vertical movement unit, in which
the controller prioritizes the control of switching the phase pattern to be displayed on the spatial light modulator, the control of switching the focal length of the optical unit, and the control of movement of the vertical movement unit in this order.
   (10)

The beam shaping device according to any one of (1) to (9), in which the optical unit includes a liquid crystal lens that has a focal length variable.

(11)

The beam shaping device according to any one of (1) to (9), in which the optical unit includes a spatial light modulator that has a focal length variable.

(12)

The beam shaping device according to any one of (1) to (9), in which the optical unit includes a revolver-type variable focal length lens.

(13)

The beam shaping device according to any one of (1) to (9), in which the optical unit includes a liquid lens that has a focal length variable.

(14)

A machining device including:
a spatial light modulator of phase modulation type that displays a phase pattern corresponding to an irradiation pattern to be applied to an object to be machined; and
an optical unit that has a focal length variable and that converges light modulated by the spatial light modulator on the object.

The present application claims the benefit of Japanese Priority Patent Application JP2022-084837 filed with the Japan Patent Office on May 24, 2022, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A beam shaping device comprising:
a spatial light modulator of phase modulation type that displays a phase pattern corresponding to an irradiation pattern to be applied to an object; and
an optical unit that has a focal length variable and that converges light modulated by the spatial light modulator on the object.

2. The beam shaping device according to claim 1, wherein the spatial light modulator displays, as the phase pattern, a pattern obtained by superposing a pattern for focal shift that shifts a focal position by the optical unit in a vertical direction on a pattern corresponding to the irradiation pattern.

3. The beam shaping device according to claim 1, wherein the spatial light modulator displays, as the phase pattern, a pattern obtained by superposing a pattern for correction that corrects an aberration generated by the optical unit on a pattern corresponding to the irradiation pattern.

4. The beam shaping device according to claim 1, wherein the spatial light modulator displays, as the phase pattern, a pattern obtained by superposing a pattern for correction that corrects an aberration generated by a base material of the object on a pattern corresponding to the irradiation pattern.

5. The beam shaping device according to claim 1, further comprising a controller that performs control of switching the phase pattern to be displayed on the spatial light modulator and control of switching the focal length of the optical unit, wherein the controller performs control of prioritizing the control of switching the phase pattern to be displayed on the spatial light modulator as compared with the control of switching the focal length of the optical unit.

6. The beam shaping device according to claim 1, further comprising a horizontal movement unit configured to move the object in a horizontal direction.

7. The beam shaping device according to claim 6, further comprising a controller that performs control of switching the phase pattern to be displayed on the spatial light modulator, control of switching the focal length of the optical unit, and control of movement of the horizontal movement unit, wherein
the controller prioritizes the control of switching the phase pattern to be displayed on the spatial light modulator, the control of switching the focal length of the optical unit, and the control of movement of the horizontal movement unit in this order.

8. The beam shaping device according to claim 1, further comprising a vertical movement unit that is configured to move the object or the spatial light modulator and the optical unit in a vertical direction.

9. The beam shaping device according to claim 8, further comprising a controller that performs control of switching the phase pattern to be displayed on the spatial light modulator, control of switching the focal length of the optical unit, and control of movement of the vertical movement unit, wherein
the controller prioritizes the control of switching the phase pattern to be displayed on the spatial light modulator, the control of switching the focal length of the optical unit, and the control of movement of the vertical movement unit in this order.

10. The beam shaping device according to claim 1, wherein the optical unit comprises a liquid crystal lens that has a focal length variable.

11. The beam shaping device according to claim 1, wherein the optical unit comprises a spatial light modulator that has a focal length variable.

12. The beam shaping device according to claim 1, wherein the optical unit comprises a revolver-type variable focal length lens.

13. The beam shaping device according to claim 1, wherein the optical unit comprises a liquid lens that has a focal length variable.

14. A machining device comprising:
a spatial light modulator of phase modulation type that displays a phase pattern corresponding to an irradiation pattern to be applied to an object to be machined; and
an optical unit that has a focal length variable and that converges light modulated by the spatial light modulator on the object.
